(19) United States
(12) Patent Application Publication
(10) Pub. No.: US 2007/0035679 A1
(43) Pub. Date: Feb. 15, 2007

(54) Backlight unit and liquid crystal display having the same

(75) Inventors: Seung-jae Lee, Suwon-si (KR); Dong-seob Jang, Seoul (KR); Seong-ho Youn, Hwaseong-si (KR); Chang-ju Kim, Suwon-si (KR); Hye-eun Park, Suwon-si (KR)

Correspondence Address: STANZIONE & KIM, LLP, 919 18TH STREET, N.W., SUITE 440, WASHINGTON, DC, 20006, US

(73) Assignee: SAMSUNG Electronics Co., Ltd., Suwon-si (KR)

(21) Appl. No.: 11/500,312

(22) Filed: Aug. 8, 2006

(30) Foreign Application Priority Data
Aug. 11, 2005 (KR) 2005-73743

(51) Int. Cl. G02F 1/1335; G02F 1/1333

(52) U.S. Cl. 349/58; 349/95

(57) ABSTRACT

A backlight unit for a LCD panel includes a point light source circuit board, a plurality of point light sources mounted on the point light source circuit board, and an optical plate disposed on an upper part of the point light source and having a Fresnel lens formed on a planar surface the optical plate. Accordingly the back light unit has a good light emitting efficiency.

### CROSS-REFERENCE TO RELATED APPLICATIONS

This application claims the priority of Korean Patent Application No. 2005-0073743, filed on Aug. 11, 2005, in the Korean Intellectual Property Office, which is hereby incorporated in its entirety by reference.

### BACKGROUND OF THE INVENTION

1. Field of the Invention

The present general inventive concept relates to a backlight unit and a liquid crystal display having the same, and more particularly, to a backlight unit and a liquid crystal display having the same in which a Fresnel lens is disposed on an upper part of a point light source to enhance light emitting efficiency.

2. Description of the Related Art

Recently, a flat panel display apparatus, such as a liquid crystal display (LCD), a plasma display panel (PDP), and an organic light emitting diode (OLED), has been developed to substitute for a conventional display such as a cathode ray tube (CRT).

An LCD an LCD panel having a thin film transistor (TFT) substrate and a color filter substrate, and a liquid crystal disposed therebetween. Since the LCD panel does not emit light by itself, the LCD comprises a backlight unit in back of the TFT substrate as a light source for providing light. The transmittance of the light emitted from the backlight unit is adjusted according to an arrangement of the liquid crystal. The LCD panel and the backlight unit are accommodated in a chassis.

Depending on the location of the light source, the backlight unit may be classified as either an edge type backlight unit or a direct type backlight unit. The edge type backlight unit is provided with the light source at a lateral side of a light guiding plate and is typically used for relatively small sized LCDs, such as those used in laptops and desktop computers. The edge type backlight unit provides high light uniformity and good endurance, and is suitable for use in thin profile LCDs.

As the size of the LCD panel has increased in the market, the development of the direct type backlight unit have become increasingly emphasized. The direct type backlight unit provides light on the entire surface of the LCD panel by disposing a plurality of light sources in a rear side of the LCD panel. The direct type backlight unit provides a high level of brightness by using a plurality of light sources, as compared with the edge type backlight unit, but the brightness is generally not sufficiently uniform.

A conventional LED, which is a point light source, not a linear light source like a lamp, has been recognized as a suitable light source for the direct type backlight unit.

An optical member, such as a prism sheet for enhancing the brightness of the light emitted from the point light source, is used for the backlight unit.

However, since the conventional optical member is not adjusted for each point light source, the light emitting efficiency is decreased.

### SUMMARY OF THE INVENTION

Accordingly, the present general inventive concept provides a back light unit having a good light emitting efficiency.

Accordingly, the present general inventive concept provides an LCD including a back light unit.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept may be achieved by providing a backlight unit, comprising a light source circuit board, a plurality of light sources mounted on the light source circuit board, and an optical plate disposed on an upper part of the point light source and having a Fresnel lens formed on a planar surface of the optical plate.

The Fresnel lens may be formed on an upper side of the optical plate.

The optical plate may be transparent.

A focal distance of the Fresnel lens may be between 5 mm and 2000 mm.

The height of a serration of the Fresnel lens may be between 0.01 mm and 2 mm.

The thickness of the optical plate may be between 0.3 mm and 20 mm.

The point light source may comprise an LED device.

The backlight unit may further comprise a diffusion sheet disposed above the optical plate.

According The Fresnel lens may correspond to each light source.

The plurality of light sources may constitute a light source unit to provide a white-colored light, and the Fresnel lens may correspond to each light source unit.

The backlight unit may further comprise a diffusion lens disposed above the point light source.

The foregoing and/or another aspects and utilities of the present general inventive concept may also be achieved by providing a liquid crystal display, comprising, a liquid crystal display panel, a light source circuit board disposed in rear of the liquid crystal display panel; a plurality of a light sources mounted on the light source circuit board, and an optical plate disposed between the light sources and the liquid crystal display panel, and having a Fresnel lens formed on a planar surface of the optical plate.

The Fresnel lens may be formed on an upper side of the optical plate facing the liquid crystal display panel.

The optical plate may be transparent.

A focal distance of the Fresnel lens may be between 5 mm and 2000 mm.

The height of a serration of the Fresnel lens may be between 0.01 mm and 2 mm.

The thickness of the optical plate may be between 0.3 mm and 20 mm.

The light source may comprise an LED device.

The liquid crystal display may further comprise a diffusion sheet disposed above the optical plate.

The Fresnel lens may correspond to each light source.

The plurality of light sources may constitute a light source unit to provide white-colored light, and the Fresnel lens may correspond to each light source unit.

The liquid crystal display may further comprise a diffusion lens disposed above the light source.

The foregoing and/or other aspects and utilities of the present general inventive concept may also be achieved by providing a display comprising a display panel, and a backlight unit disposed to generate light to a major surface of the display panel, the backlight unit comprising a circuit board, a plurality of light sources mounted on the circuit board, and an optical plate disposed between the display unit and the plurality of light sources and having a Fresnel lens formed on a surface of the optical plate.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is an exploded perspective view illustrating a liquid crystal display according to an embodiment of the present general inventive concept;

FIG. 2 is a sectional view illustrating the liquid crystal display of FIG. 1;

FIG. 3 is a view illustrating an arrangement of an LED device and a Fresnel lens in the liquid crystal display of FIG. 1;

FIG. 4 is a sectional view illustrating the Fresnel lens of FIG. 3;

FIG. 5 is a graph illustrating an improvement of the brightness when a Fresnel lens according to the present general inventive concept is used;

FIG. 6 is a view illustrating an arrangement of an LED device including a plurality of Fresnel lenses according to an embodiment of the present general inventive concept;

FIG. 7 is a view illustrating an arrangement of an LED device including a Fresnel lens to correspond with a plurality of LED devices according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below so as to explain the present invention by referring to the figures.

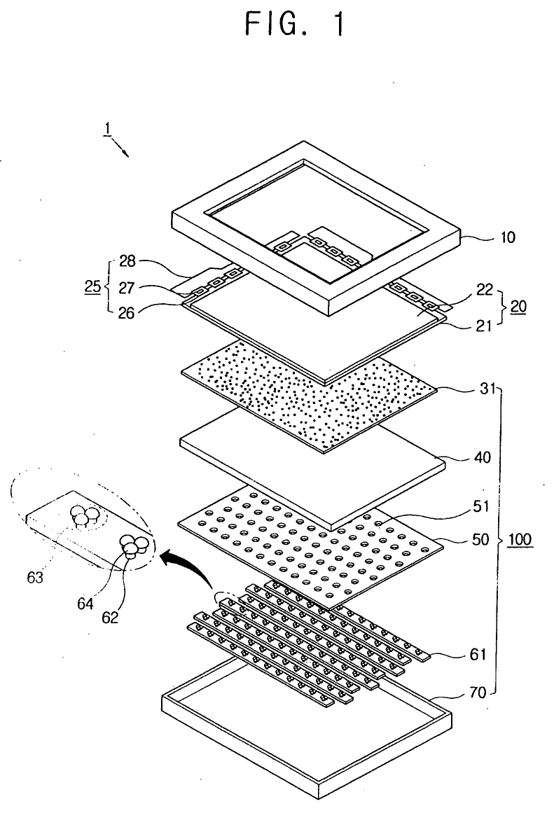

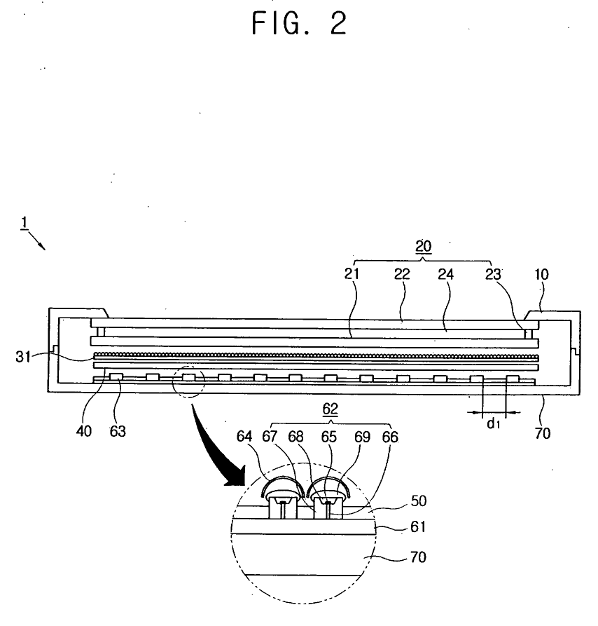

An embodiment of the present general inventive concept will be illustrated with reference to FIGS. 1 through 4.

An LCD 1 comprises an LCD panel 20 and a backlight unit 100 providing light to the back side of the LCD panel 20. The backlight unit 100 comprises a diffusion sheet 31, an optical plate 40, a reflecting plate 50, an light emitting diode (LED) circuit board 61, and LED devices 62 mounted on the LED circuit board 61 and seated in or disposed in corresponding ones of LED apertures 51 on the reflecting plate 50. The LCD panel 20, the diffusion sheet 31, and the LED circuit board 61 are accommodated between an upper chassis 10 and a lower chassis 70.

The LCD panel 20 comprises a TFT substrate 21 on which TFTs are formed, a color filter substrate 22 facing the TFT substrate 21, a sealant 23 adhering the color filter substrate 21 and the TFT substrate 22 and forming a cell gap therebetween, and a liquid crystal layer 24 surrounded by the color filter substrate 21 and the TFT substrate 22 and the sealant 23. The LCD panel 20 controls arrangement of the liquid crystal layer 24, thereby forming an image thereon. However, the LCD panel 20 must be supplied with light from the LED devices 60 disposed at a rear side of the LCD panel 20, because the LCD panel 20 does not emit light by itself. A driving part 25 is disposed on a side of the TFT substrate 21 to apply driving signals to the LCD panel 20. The driving part 25 comprises a flexible printed circuit (FPC) 26, a driving chip 27 mounted on the flexible printed circuit 26, and a printed circuit board (PCB) 28 connected on a side of the flexible printed circuit 26. The driving part 25 may be of a COF (chip on film) type. However, other types of driving parts may be used, such as TCP (tape carrier package) or COG (chip on glass) type. In other embodiments, the driving part 25 may be formed on the TFT substrate 21 where wirings are formed.

The diffusion sheet 31 disposed in the rear side of the LCD panel 20 comprises a base plate and a coating layer having beads formed on the base plate. The diffusion sheet 31 diffuses light from the LED devices 62 to improve uniformity of brightness of the light. In another embodiment, two or more diffusion sheets 31 may be used in a different way from embodiments in which one diffusion sheet 31 is used. The diffusion sheet 31 may also be used in cooperation with a diffusion plate.

The optical plate 40 is disposed beneath the diffusion sheet 31. The optical plate 40 may be made of a transparent plastic material, such as polyethylene terephthalate (PET), or glass. A Fresnel lens 41 is disposed on an upper side of the optical plate 40 facing the diffusion sheet 31 or the LCD panel 20. A thickness d3 of the optical plate 40 may be between, for example, 0.3 mm and 20 mm. If the thickness d3 of the optical plate 40 is less than 0.3 mm, the optical plate 40 may be breakable or deformable. If the thickness d3 of the optical plate 40 is more than 20 mm, the optical efficiency may be decreased due to a transmittance decrease of a medium. A configuration and a function of the Fresnel lens 41 will be described later.

Although not illustrated in FIG. 1, the LCD 1 may further include supporters to maintain a space between the LED device 62 and the optical plate 40, and the supporters may also maintain a space between the optical plate 40 and the diffusion sheet 31.

The reflecting plate 50 is placed on a region of the LED circuit board 61 on which the LED devices 62 are not seated. The LED apertures 51 are formed in the reflecting plate 50 to correspond with an arrangement of the LED devices 62. The size of LED aperture 51 may be formed slightly bigger than each LED device unit 63. LEDs of the LED devices 62 may protrude from the reflecting plate 50 through the LED apertures 51. It is possible that a plurality of LEDs can be disposed within the LED aperture 51.

The reflecting plate 50 reflects the light directed downward from the LED device units 63 and supplies the reflected light to the optical plate 40. The reflecting plate 50 may be made of polyethylene terephthalate (PET) or polycarbonate (PC), and/or may be coated with silver (Ag) or aluminum (Al). In another embodiment, the reflecting plate 50 may be formed with a sufficient thickness so as to prevent distortion or shrinkage due to heat generated from the LED devices 62.

In the present embodiment, the LED circuit board 61 may have a plurality of LED circuit boards each having an elongated bar shape and disposed in parallel at a regular interval. Each LED circuit board 61 is disposed in parallel with a long side of the LCD panel 20 of a rectangular shape. The LED device 62 may generate a significant amount of heat when the LCD 1 is driven. Accordingly, the LCD 1 may further comprise, for example, a heat pipe, a heat radiating fin, a cooling fan, or other cooling devices, which are not shown in the drawings, to radiate the heat generated by the LED devices 62.

The LED devices 62 which are mounted on the LED circuit board 61 may be disposed on an entire rear surface of the LCD panel 20. Each LED device 62 comprises a chip 65 to generate light, a lead 66 to connect the chip 65 with the LED circuit board 61, a plastic mold 67 to accommodate the lead 66 and to support the chip 65, and a silicon part 68 and a bulb 69 which are disposed over the chip 65. The bulb 69 may be made of, for example, polymetamethylacrylate (PMMA) or epoxy resin.

A diffusion lens 64 is provided above the LED device 62. The light from the LED device 62 is emitted mainly toward an upper side of the LED device 62, and thus the brightness may not be uniform. The diffusion lens 64 diffuses the light concentrated toward the upper side of the diffusion lens 64 to disperse the light in all directions. The diffusion lens 64 may be a side emitting type in which light is emitted mainly to a lateral side, but a top emitting type may be used so as to enhance brightness. Alternatively, the light from the LED device 62 may be diffused by varying the shape of the bulb 69.

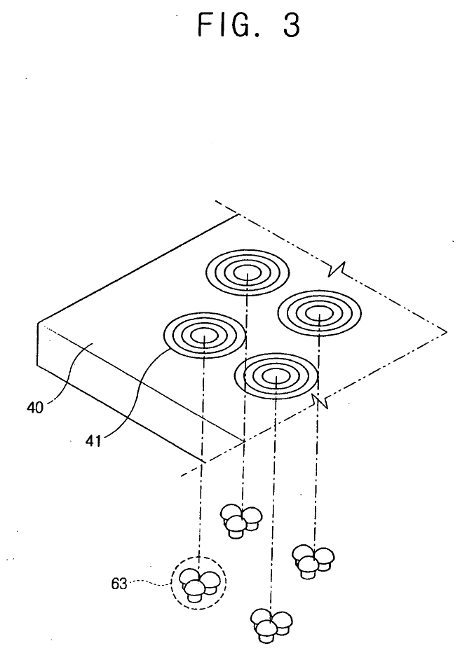

The LED device 62 may be grouped in groups of a number of LEDs or LED devices, for example, three, that may make up one LED device unit 63, which is disposed on the LED circuit board 61 of FIG. 3. The LED device unit 63 comprises may include three LED devices 62 each emitting a different color, for example, red, green, and blue colors, to provide white-colored light. The three LED devices 62 in the LED device unit 63 are disposed in a regular triangle shape. The LED device units 63 are disposed at a regular or predetermined interval on the LED circuit board 61. The LED device units 63 in the adjacent LED circuit boards 61 may be alternatively disposed with each other. A configuration and an arrangement of the LED device 62 constituting the LED device units 63 may be modified as necessary.

An arrangement of the Fresnel lens 41 mounted on the optical plate 40 and the LED device 62 is illustrated in FIG. 3.

The Fresnel lens 41 is provided over the LED device unit 63 mounted on the optical plate 40. Accordingly, the Fresnel lenses 41 are also disposed at a regular or predetermined interval on the LED circuit board 61 to correspond to the LED device unit 63.

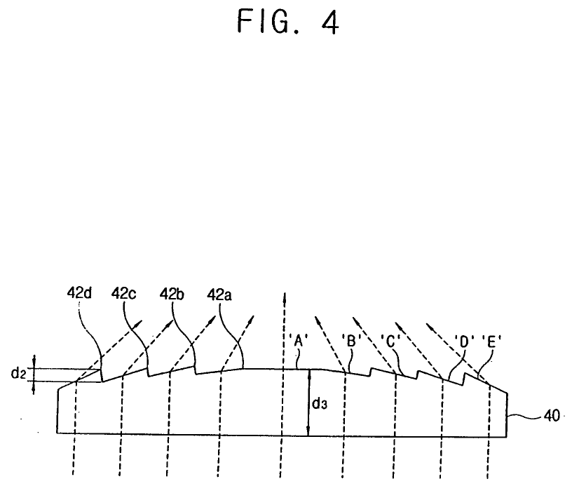

A configuration and a function of the Fresnel lens 41 disposed on the optical plate 40 are illustrated in FIGS. 3 and 4.

The Fresnel lens 41 comprises a plurality of concentric circles 42a, 42b, 42c, and 42d. Each one of the plurality of concentric circles 42a, 42b, 42c, and 42d is protruded to have a serration shape, and a height d2 of the serration. The height d2 may be between about 0.01 mm and 2 mm. If the height d2 of the serration is less than 0.01 mm, the effect due to diffraction may be increased. If the height d2 of the serration is more than 2 mm, a pattern formed by adjacent serrations alters a light path, and the quality of a picture from the LCD panel 20 may be deteriorated. A central exit surface A to emit light is relatively flat, and circumferential exit surfaces B, C, D, and E are inclined to heighten increasingly such that inclination angles are increased approaching the central exit surface A. Inclination angles of the circumferential exit surfaces B, C, D and E are increased going away from the central exit surface A. Thus, the light entering into a portion which is increasingly distant from the central exit surface A is more refracted so that the refracted light faces the center of the Fresnel lens 41. Accordingly, light emitted from the LED device 62 can be directed to a desired effective range and may thus be collected. According to the present embodiment, the collection of light may be performed individually for each LED device unit 63.

In another embodiment, it is possible that a focal distance of the Fresnel lens 41 is between 5 mm and 2000 mm. If the focal distance is less than 5 mm, only a portion of the light emitted from the diffusion lens 64 passes through an effective diameter, because an area of the Fresnel pattern obtainable from plastic material having about 1.5 of refractivity becomes narrow. If the focal distance is more than 2000 mm, there is almost no improvement of the brightness by the Fresnel lens 41.

According to the present embodiment, the light efficiency and the brightness is improved since the optimum light collection can be accomplished for each LED device unit 63. Accordingly, a distance d1 between the LED device units 63 may be be increased and thus the number of the LED device units 63 can be decreased. Accordingly, as the number of the LED device units 63 is decreased, power consumption is also decreased and thus heat generated from the LED device units 63 can be decreased. Moreover, the cost for heat dissipation can be reduced and also a life span of the LED device 62 can be extended.

The configuration and the arrangement of the LED device unit 63 of the embodiment of FIG. 1-4 may be modified as necessary. In addition, the shape of the Fresnel lens 41 may be also modified such that the light path from the Fresnel lens 41 is altered. The Fresnel lens 41 may be formed on a lower side of the optical plate 40 facing the LED device 62 or it may be formed on both of the upper side and the lower side of the optical plate 40. The size and the shape of the Fresnel lenses 41 may be different within the same optical plate 40. Particularly, the size and the shape of the Fresnel lenses 41 may be different in a central portion and a circumferential portion of the optical plate 40.

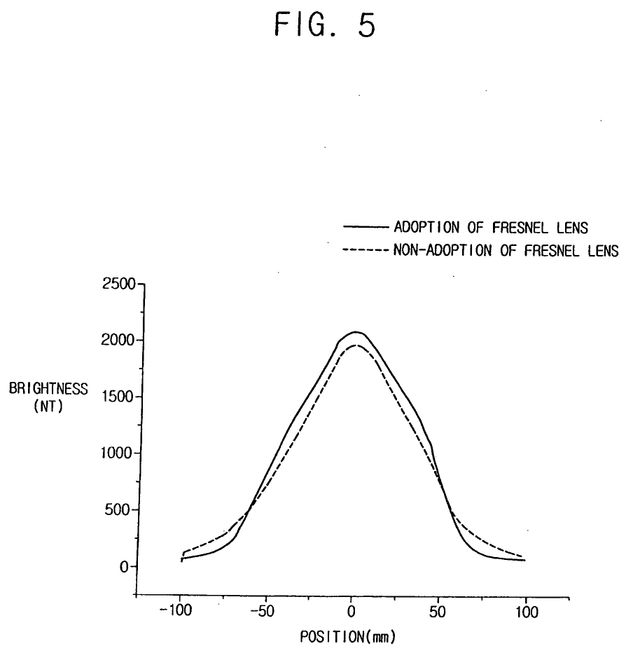

FIG. 5 is a graph illustrating an improvement of the brightness when the Fresnel lens 41 according to the present embodiment is used. Table 1 shows experimental results.

TABLE 1

| | Maximum | Gaussian fitting value | |
|---|---|---|---|
| | brightness | Integrated amount | |
| | (nt.) | of light (nt.) | 2σ (mm) |
| Non-adoption of | 2024 | 162087 | 69.4 |
| Fresnel lens | | | |
| Adoption of Fresnel | 2271 | 203723 | 74.2 |
| lens | | | |

In the experiment, the LED device unit 63 that had 4 LED devices 62 was used. A measurement of the brightness was made for each portion of the screen being apart from the LED device unit 63 by a predetermined distance. The LED device unit 63 included four LEDS, a red LED, a blue LED and a pair of green LEDs.

As can be seen in the measurement result, it was found that a maximum brightness was increased by approximately 12 percent, and the integrated amount of light was increased by 25.7 percent in positions between −100 mm and 100 mm, with respect to the center of the LED device unit 63, using the Fresnel lens 41. Also, a 2σ value was increased by 6.9 percent, which means that even though the distance between the LED device units 63 is increased, the same brightness can be achieved.

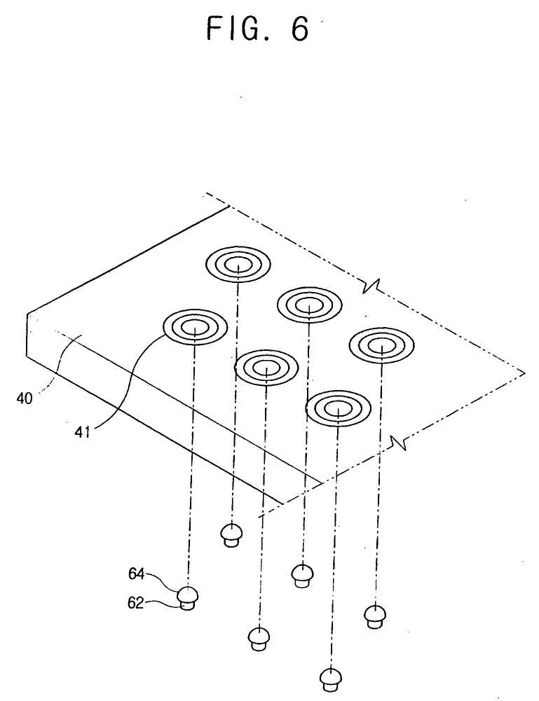

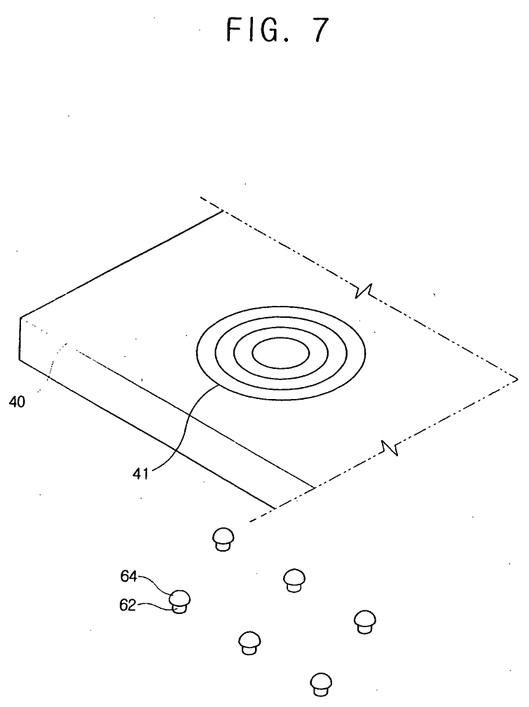

FIG. 6 is a graph illustrating an arrangement between the LED devices and the Fresnel lenses according to a second embodiment of the present general inventive concept. FIG. 7 is a graph illustrating an arrangement between the LED devices and the Fresnel lenses according to a third embodiment of the present general inventive concept.

In an embodiment illustrated in FIG. 6 each of the LED devices 62 may be disposed at a regular interval. Each Fresnel lens 41 may be formed to correspond to each LED device 62 mounted on an optical plate 40.

In an embodiment illustrated in FIG. 7, the LED devices 62 are disposed at a regular interval as in the embodiment of FIG. 6. Each Fresnel lens 41 disposed on the optical plate 40 corresponds to each LED device 62.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A backlight unit, comprising:
a light source circuit board;
a plurality of light sources mounted on the light source circuit board; and
an optical plate disposed on an upper part of the light source and having a Fresnel lens formed on a planar surface of the optical plate.

2. The backlight unit according to claim 1, wherein the Fresnel lens is formed on an upper side of the optical plate.

3. The backlight unit according to claim 2, wherein the optical plate is transparent.

4. The backlight unit according to claim 2, wherein a focal distance of the Fresnel lens is between 5 mm and 2000 mm inclusive.

5. The backlight unit according to claim 1, wherein a height of a serration of the Fresnel lens is between 0.01 mm and 2 mm inclusive.

6. The backlight unit according to claim 1, wherein a thickness of the optical plate is between 0.3 mm and 20 mm inclusive.

7. The backlight unit according to claim 1, wherein the light source comprises an LED device.

8. The backlight unit according to claim 1, further comprising:
a diffusion sheet disposed above the optical plate.

9. The backlight unit according to claim 1, wherein the Fresnel lens corresponds to each light source.

10. The backlight unit according to claim 1, wherein the plurality of light sources constitute a light source unit to provide a white-colored light, and the Fresnel lens corresponds to each light source unit.

11. The backlight unit according to claim 1, further comprising a diffusion lens disposed above the light source.

12. A liquid crystal display, comprising:
a liquid crystal display panel;
a light source circuit board disposed in a rear side of the liquid crystal display panel;
a plurality of light sources mounted on the light source circuit board; and
an optical plate disposed between the plurality of light sources and the liquid crystal display panel; and having a Fresnel lens formed on a planar surface of the optical plate.

13. The liquid crystal display according to claim 12, wherein the Fresnel lens is formed on an upper side of the optical plate facing the liquid crystal display panel.

14. The liquid crystal display according to claim 12, wherein the optical plate is transparent.

15. The liquid crystal display according to claim 12, wherein a focal distance of the Fresnel lens is between 5 mm and 2000 mm inclusive.

16. The liquid crystal display according to claim 12, wherein a height of a serration of the Fresnel lens is between 0.01 mm and 2 mm inclusive.

17. The liquid crystal display according to claim 12, wherein a thickness of the optical plate is between 0.3 mm and 20 mm inclusive.

18. The liquid crystal display according to claim 12, wherein the light source comprises an LED device.

19. The liquid crystal display according to claim 12, further comprising a diffusion sheet disposed above the optical plate.

20. The liquid crystal display according to claim 12, wherein the Fresnel lens corresponds to each light source.

21. The liquid crystal display according to claim 12, wherein the plurality of light sources constitute a light source unit to provide white-colored light, and the Fresnel lens corresponds to each light source unit.

22. The liquid crystal display according to claim 12, further comprising a diffusion lens disposed above the light source.

23. A display, comprising:
a display panel; and
a backlight unit disposed to generate light to a major surface of the display panel, the backlight unit comprising:
a circuit board,
a plurality of light sources mounted on the circuit board, and
an optical plate disposed between the display unit and the plurality of light sources and having a Fresnel lens formed on a surface of the optical plate.

24. The display of claim 23, further comprising:
a reflecting plate having a plurality of apertures to accommodate at least one of the light sources protruding from the circuit board toward the optical plate to reflect light from the light source toward the optical plate.

25. The display of claim 24, wherein the plurality of light sources each comprise:
a plastic mold mounted on the circuit plate and disposed in the corresponding aperture;
a chip mounted on the plastic mold;
a lead disposed in the plastic mold to connect the chip to a circuit of the circuit board to supply power to the chip;
a bulb mounted on the plastic mold and over the chip; and
a diffusion lens to diffuse the light transmitted from the chip through the bulb.

26. The display of claim 23, wherein the Fresnel lens comprises a central exit surface disposed on a center axis of the light sources, and a plurality of circumferential exit surfaces disposed to surround the central exit surface having different diffusion angles according to a distance from the central exit surface.
